(19) United States
(12) Patent Application Publication
(10) Pub. No.: US 2002/0030020 A1
(43) Pub. Date: Mar. 14, 2002

(54) Efficient and economical use of activated carbon for treating chemical-contaminated drinking water

(76) Inventors: Jack Moorehead, San Diego, CA (US); Joseph T. Lodico, San Diego, CA (US)

Correspondence Address: FRANK G MORKUNAS, 7750 DAGGET ST, SUITE 203, SAN DIEGO, CA, 92111

(21) Appl. No.: 09/950,745

(22) Filed: Sep. 10, 2001

Related U.S. Application Data
(63) Continuation-in-part of application No. 09/732,164, filed on Dec. 7, 2000.
Application No. 09/732,164 is a continuation-in-part of application No. 09/524,578, filed on Mar. 13, 2000.

(51) Int. Cl. C02F 1/00

(52) U.S. Cl. 210/741; 210/104

(57) ABSTRACT

A system for the treatment of chemical-contaminated drinking water having one or more first stage light-weight column assemblies and one or more second stage light-weight column assemblies with each of the columns having a self-contained detachable cartridge with an adsorption substance therein. A water stream is selectively directed to either stage for treatment after which the water stream selectively directed via a first or a second cross-over valve, to the other stage for treatment. A sensor on the column assembly detects when the adsorption substance has become saturated, triggers an alarm. Special pallets are designed to store and hold new cartridges and to store and hold spent cartridges.

### CROSS REFERENCES TO RELATED APPLICATIONS

This application is a continuation-in-part of related co-pending U.S. Patent applications, application Ser. No. 09/524,578, filed on Mar. 13, 2000, and application Ser. No. 09/732,164, filed on Dec. 7, 2000.

### STATEMENT REGARDING FEDERALLY-SPONSORED RESEARCH OR DEVELOPMENT

None.

### BACKGROUND OF THE INVENTION

This present invention relates to an improvement in water treatment systems, and more particularly to systems using a filtration/adsorption substance such as, but not limited to, granular activated carbon. Granular activated carbon is used to remove toxic chemicals from large municipal water treatment facilities after treatment of the water and prior to dispensing for use. As currently practiced, such use is impractical, not to mention, expensive for the following reasons. Replacement of the spent carbon saturated with toxic chemicals requires special equipment (for removal, hauling, transporting), onsite labor activities, and specially-trained personnel. To limit how often such special carbon transportation equipment must be used, large carbon tanks are employed to extend the cycle time and thereby limit the frequency of replacement. As a result, this reduces the number of trips these special carbon-hauling vehicles must make each year. In such systems, which are not atypical, two large metal tanks, each containing ten thousand pounds of carbon, are used to treat a 200 gallon-per-minute (GPM) ground water process stream flow (a typical process flow) which is, for example, lightly contaminated with Benzene or MTBE from a leaking underground gasoline storage tank (not atypical of most ground water streams).

Removing spent carbon and replacing it with clean carbon material requires very special vehicles which are capable of simultaneously hauling 10,000 pounds of clean carbon, 10,000 pounds of wet spent carbon, and large containers to hold both the wet spent carbon and to hold the clean carbon separate from the wet spent carbon. Clean carbon is generally brought to the tank site in bags. Spent carbon is suctioned out or flushed out of the tank and loaded onto the truck. Bag by bag, the tank, without being cleansed or detoxified, is then filled with new carbon. The wet spent carbon generally is taken to a central collection site, of which there are few, for recycling or disposal. As a result, these central collection locations may be in another county or in a different State altogether. The greater the distance from removal site to disposal site, the greater the transportation costs. All these factors, add substantially to the overall operating costs of a water treatment processing facility.

Other cost factors include the price of replacement carbon. These prices will vary depending on the quality of the carbon, the size of the transportation equipment, and, among other factors, regional labor costs. Trucks with a smaller load capacity require more frequent trips, which increases labor costs and overhead costs. Trucks with a larger capacity, though more effective, are extremely expensive to operate and even more expensive to own. Very few small service contractors can afford to own and operate large carbon transfer equipment. This reality restricts competition and also serves to increase the cost of this service to the end user.

Although expensive, granular activated carbon (GAC) is the chemical of choice for the adsorption out of chemical contaminants in such treatment systems. It is a highly porous form of carbon derived from coal, wood, and coconut shells and is well-suited for chemical-contaminant adsorption from a water stream. Conventional activated carbon systems are used for both adsorption and physical screening of contaminants. The carbon adsorbs chemical contaminants by collecting organic molecules and other substances in its porous surface. Conventional municipal-sized granular activated carbon (GAC) systems contain loose granules in large tanks that will allow process water to channel through the carbon bed when clogged with suspended solids, such as algae or silt. In this regard, these channels form openings which cause the process water stream to bypass the partially clogged granular carbon. Because of the large volume of loose granular carbon inside each tank, the water tends to “channel” through the carbon-fill material rather than to adsorb the chemicals in the process water stream.

To counter this effect, most such systems use staggered baffles (see FIG. 1); e.g., top baffle extending from a first side past the middle toward the other side, next baffle below extending from the other side past the middle toward the first side, the next baffle below being similar to the top baffle, and so on. The purpose of such staggering is to cause the water to flow more evenly through the carbon; but this also has proven not to be very efficient. This staggered channeling causes the carbon material to become more saturated in one area and less saturated or “dryer” in other areas. This, in effect, is a waste of the expensive carbon materials used therein since some of the carbon is not utilized at all and, when the tank is cleared of ‘spent’ carbon, the non-utilized carbon is discard along with the spent carbon. Granular activated carbon (GAC) manufacturers, therefore, often install larger carbon systems than necessary in order to compensate for this uneven adsorption/utilization reality. Using more carbon in a system than is necessary, clearly increases the capital investment for such a system and increases the operating costs of the system.

On average, carbon in a conventional 10,000-pound capacity tank as described above, in the typical environment described above, is replaced approximately every 60 days (this time frame is also dependent on the concentration of contaminants in the raw process water being treated). Pretreating the raw process water in a system as described in related patent application Ser. Nos. 09/524,578 and/or 09/732,164, for example, before directing it to the tank increases the adsorption capacity/duration of effectiveness of the carbon by about ten-times.

If 800 pounds of carbon is changed every three months (the average result of the present invention) rather than 10,000 pounds every 60 days (as in the prior art), one can reduce the volume of carbon required by about 85%, providing that the system of the present invention is employed which utilizes, for example, a eight-column first or eight-column second stage (each column containing about 100 pounds of carbon) is replaced every three months, along with a pre-treatment system. The tanks on these columns are cartridge-like, self-contained, smaller, lighter, and, thereby easy to replace. They can be transported by conventional commercial freight carriers thereby also eliminating the need for special transportation equipment and specially-trained personnel. The concomitant result is a dramatic reduction in labor costs, in transportation costs, costs relative to onsite carbon replacement, and costs of carbon in that less carbon is required. When the carbon within the cartridge is no longer active, the cartridge is easily removed and exchanged for a new cartridge pre-filled with clean carbon. The old cartridge containing spent carbon is transported to a collection facility at which the spent carbon is removed, the cartridge cleaned/detoxified, and replaced with fresh carbon.

Pretreating a water stream before filtering the water stream with GAC reduces suspended solids and some dissolved volatile chemicals. Using the filtration/adsorption system envisioned by the present invention along with a pretreatment system prior to such adsorption, as described in related previously filed patent applications (application Ser. Nos. 09/524,578 and 09/732,164) can extend the service life of carbon by a factor of ten. Instead of replacing 10,000 pounds of spent carbon filter material every 60 days, using efficient pretreatment equipment and systems (for best results, those systems described in the above-referenced patent applications) can extend the service life of the carbon to approximately 600 days, and in some cases, up to 20 months.

As can be easily seen, this process dramatically reduces costs associated with equipment need and carbon replacement costs. Conventional carbon treatment systems are also impractical for rural communities which, ironically, are at a greater contamination risk and yet cannot afford this expensive conventional carbon adsorption equipment. This unique invention makes it possible for small rural communities with Benzene, MTBE, Nitrate pesticides and other cancer-causing chemicals in their surface or ground water to purchase this more efficient carbon adsorption equipment to remove the chemicals from their ground water and reduce the health risk to their community.

Accordingly, several objects and advantages of my invention are to:

a. provide an effective and efficient filtration/adsorption system;

b. decrease the costs associated with similar filtration/adsorption systems using larger tanks;

c. eliminate the need for special equipment and specially-trained personnel in replacing adsorption system tanks;

d. extend the useful life of the adsorption substance within tanks;

e. facilitate the handling and hauling of tanks; and

f. provide an easy-to-use, easy-to-maintain, and easy-to-replace tank.

The foregoing has outlined some of the more pertinent objects of the present invention. These objects should be construed to be merely illustrative of some of the more prominent features and applications of the intended invention. Many other beneficial results can be attained by applying the disclosed invention in a different manner or by modifying the invention within the scope of the disclosure. Accordingly, other objects and a fuller understanding of the invention may be had by referring to the summary of the invention and the detailed description of the preferred embodiment in addition to the scope of the invention defined by the claims taken in conjunction with the accompanying drawings.

### BRIEF SUMMARY OF THE INVENTION

The above-noted problems, among others, are overcome by the present invention. Briefly stated, the present invention contemplates a system for the treatment of chemical-contaminated drinking water. This system has one or more first stage lightweight column assembly and one or more second stage light-weight column assembly with each of the columns having an inlet, an outlet, a base having a base plate and a base flow pipe in the base which is in communication with the inlet, a self-contained cartridge (tank) detachable from the base, a adsorption substance within the cartridge, a holding screen on the top and bottom of the cartridge for holding the adsorption substance within, a flow pipe in the cartridge attached to and in communication with the base flow pipe, and a flow distributor at the top of the cartridge in communication with the flow pipe; inlet means for selectively directing a water stream to the inlet of either stage column; and an outlet means for selectively directing a stream from the outlet of either stage column to the inlet of the opposite stage column and for directing discharge of treated water from the system. A sensing means detects when the adsorption substance has become saturated with contaminants it is designed to remove and signals an alarm indicating need to replace the cartridge.

The foregoing has outlined the more pertinent and important features of the present invention in order that the detailed description of the invention that follows may be better understood so the present contributions to the art may be more fully appreciated. Additional features of the present invention will be described hereinafter which form the subject of the claims. It should be appreciated by those skilled in the art that the conception and the disclosed specific embodiment may be readily utilized as a basis for modifying or designing other structures and methods for carrying out the same purposes of the present invention. It also should be realized by those skilled in the art that such equivalent constructions and methods do not depart from the spirit and scope of the inventions as set forth in the appended claims.

### BRIEF DESCRIPTION OF THE DRAWINGS

For a fuller understanding of the nature and objects of the invention, reference should be had to the following detailed description taken in conjunction with the accompanying drawings in which:

FIG. 1 is a schematic representation of the prior art two-stage adsorption tank system.

FIG. 2 is a perspective view of an two-stage multi-column array adsorption system of the present invention.

FIG. 3 is a detailed view of the front of the two-stage multi-column array adsorption system of the present invention.

FIG. 4 is a detailed view of the back cross-over sections of the two-stage multi-column array adsorption system of the present invention.

FIG. 5 is an exploded view of the column assembly.

FIG. 6 is a detailed, cut-away view of the column assembly.

FIG. 7 is detailed view of the holding screen of the holding assembly.

FIG. 8 is detailed view of one section of the flow distributor.

FIG. 9 partially exploded perspective view of the pallet assembly for transporting new and used cartridges.

### DETAILED DESCRIPTION OF THE INVENTION

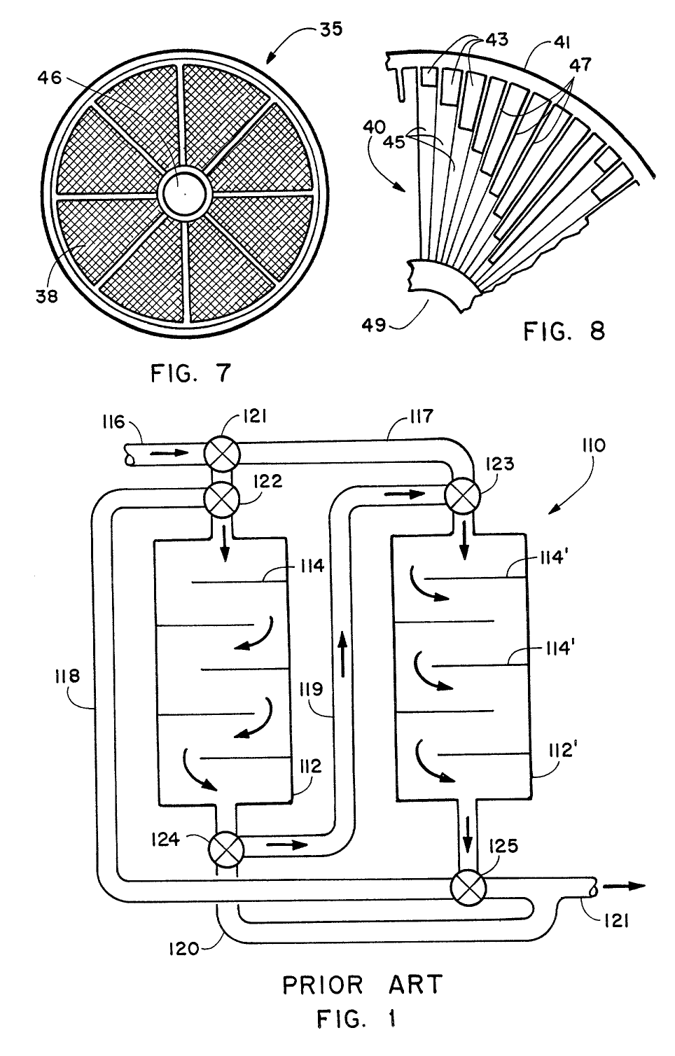

Referring now to the drawings in detail, FIG. 1 represents the prior art two-stage system 110, as described above, having two large tanks 112, 112′ utilizing carbon as a filtering/adsorbing agent and having staggered baffles 114, 114′ therein in an effort to facilitate an even flow or distribution of water therethrough. A water stream enters at the top of the first stage via pipe 116 through valve 121 and valve 122. Valve 121 is closed to pipe 117 and valve 122 is closed to pipe 118. After flowing downward by gravity, the water stream passes through valve 124 into pipe 119 through valve 123 and down into the second stage tank 112′. Valve 124 is closed to pipe 120 and valve 123 is closed to pipe 117. After flowing downward through the second stage tank 112′, the water stream passes through valve 125 into pipe 121 and out the system. Valve 125 is closed to pipe 118. As previously indicated, each tank 112, 112′ contains approximately 10,000 pounds of carbon.

To reverse the process (make the original second tank the new first tank and the original first tank the new second tank) the valves are re-set to direct the initial flow into the original second tank 112′ and then to the original first tank 112 followed by discharge from the system. The staggered baffles 114, 114′ in each tank 112, 112′, although offering some assistance to an even flow, result is channeling and run-through with loss of adsorption capability. Less carbon is utilizable and exchanging spent carbon for fresh carbon requires specialized equipment and specially trained personnel.

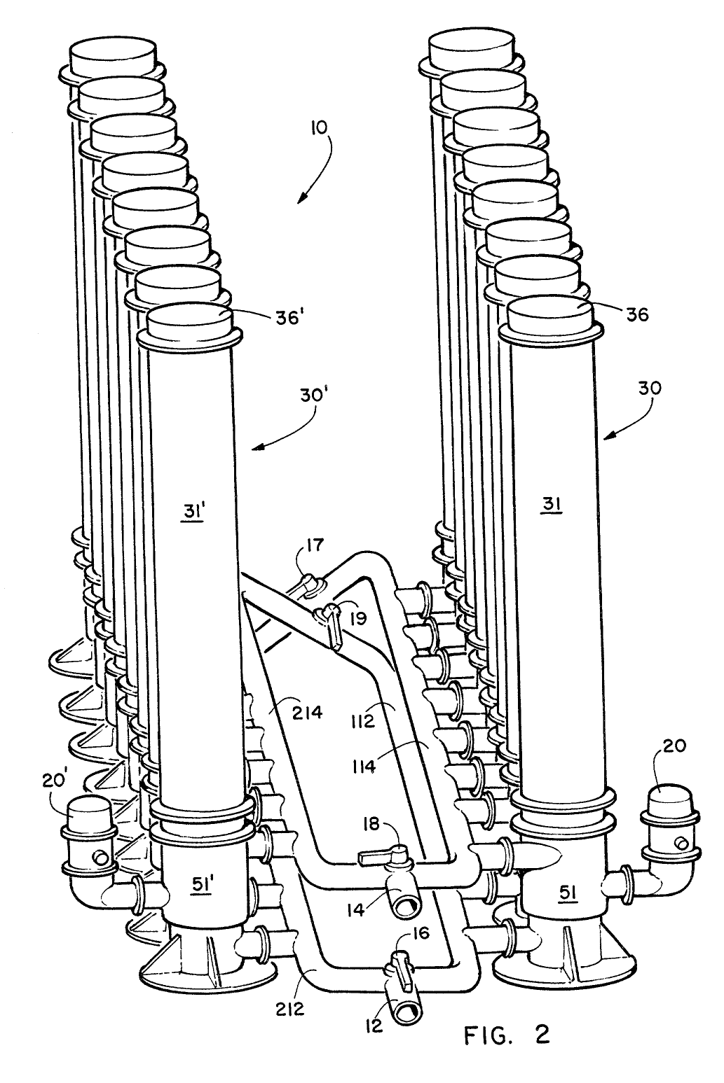

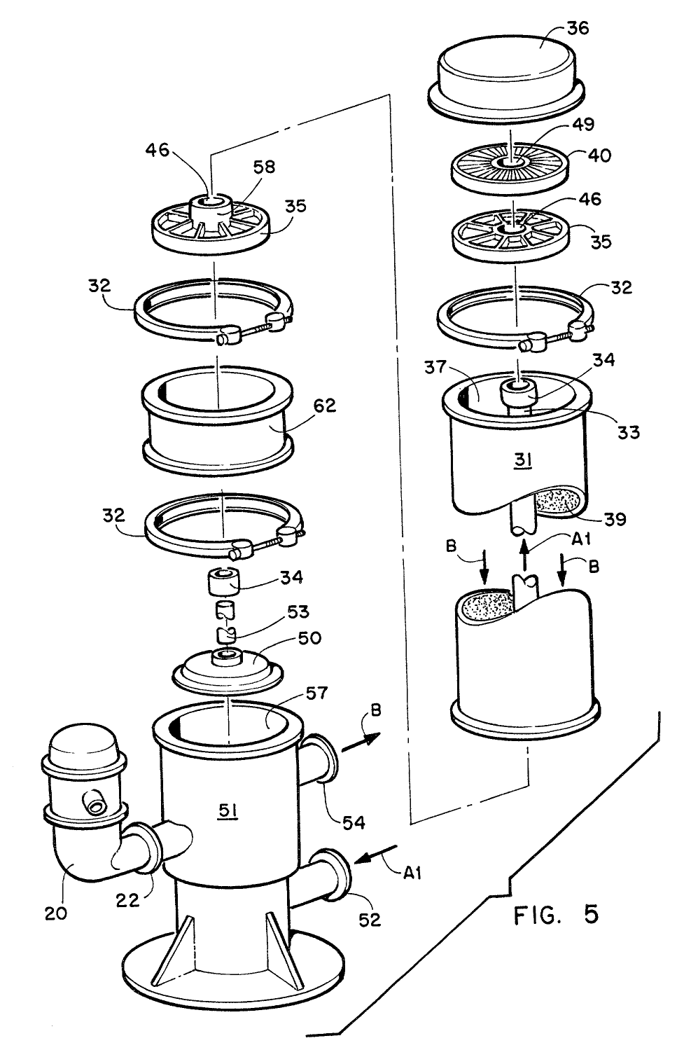

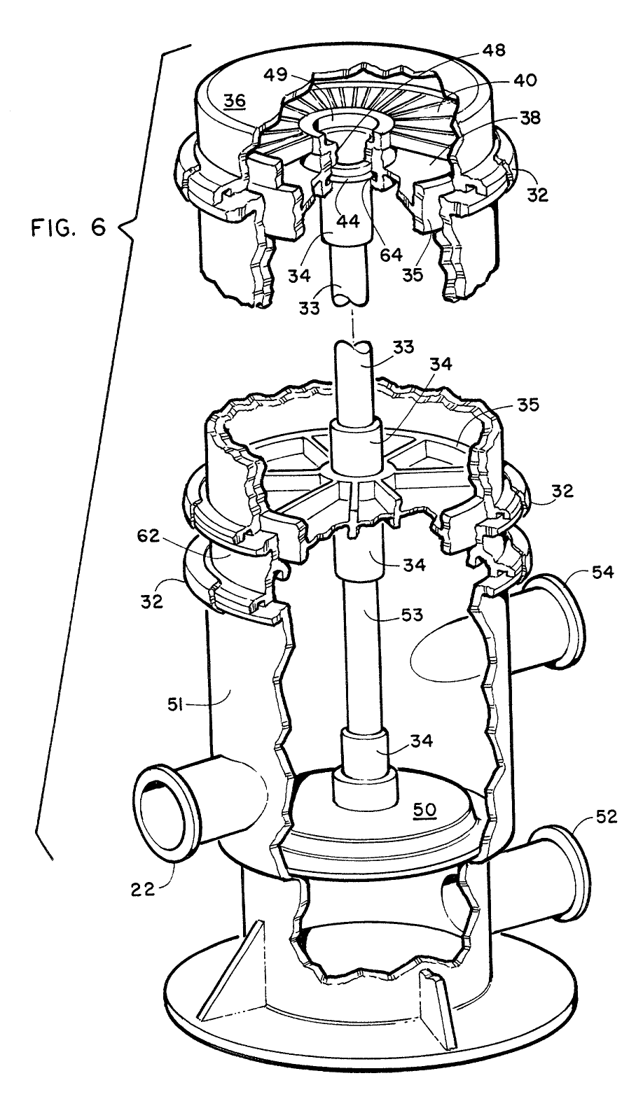

Reference should now be made to FIGS. 2 through 6 wherein reference character 10 generally designates a filtration/adsorption system constructed in accordance with a preferred embodiment of the present invention. It is a two-stage system having one or more column assemblies 30, 30′ per stage. The tank (cartridge) 31 which contains the adsorption substance, preferably granular activated carbon (GAC), is an easily removable component part of a column assembly 30 (referred to as the first stage) into which a water stream flows in, up the column assembly 30, is distributed evenly at the top to flow down through the carbon within to be discharged to a second column assembly 30′ (referred to as the second stage) which is of similar construction and function as the first column assembly 30. Each stage may comprise one or more column assemblies 30, 30′. Though the system will function well with a single column assembly in each stage 30, 30′, better results will be achieved when two or more column assemblies 30, 30′ are utilized. Using more column assemblies results in less frequent cartridge 31 replacement. Of course, how many or how few column assemblies 30, 30′ are to be used will depend on the local environmental conditions, regulations, and funds available.

When more than one column assembly 30, 30′ is used for each stage (referred to as an array), though not required, it is best to have equal numbers of column assemblies 30, 30′ in both stages. FIG. 2 illustrates an array of eight separate parallel column assemblies 30, 30′ for each stage. Eight column assemblies are best suited for typical treatment needs and facilitates storage and hauling requirements. Each column assembly 30, 30′ has a column base 51, 51′, an inlet port 52, 52′, and an outlet port 54, 54′. One column assembly 30, 30′ has at least one sensor assembly 20, 20′ for each stage. As illustrated, the sensor assembly 20, 20′ is on the first column assembly 30, 30′ of each array.

By this illustration, a water stream enters the system via the intake pipe 12 (represented by reference arrow A) and is selectively directed by a three-way intake valve 16 to inlet pipe 112 in the direction of arrows Al to the first stage. For reference purposes, position X for valve 16 is in a closed position for stage two and directs the water stream to the first stage via intake pipe 12 to the inlet pipe 112; position Y for the intake valve 16 is the closed position for stage one and would direct the water stream to the second stage via intake pipe 12 to the inlet pipe 212.

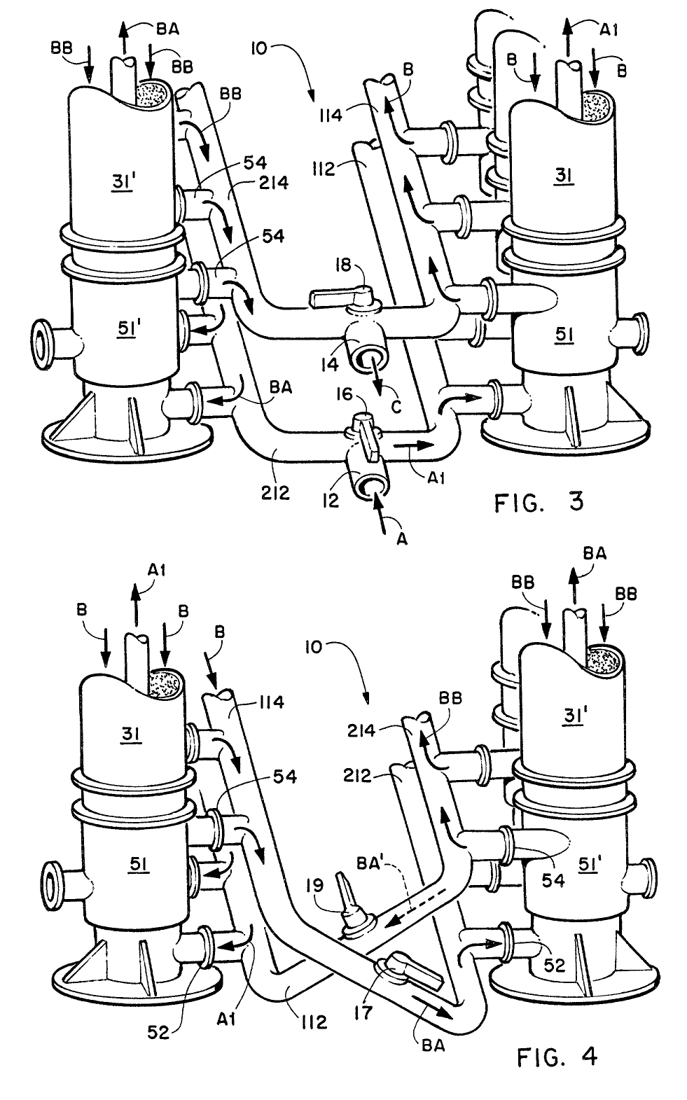

Through inlet pipe 112 the water stream will enter each column assembly 30 in the first stage array via the inlet port 52 and up the cartridge flow pipe 33 in the direction of arrow Al as illustrated in FIG. 3. After reaching the top, the water stream will be distributed much more evenly than prior art designs through a uniquely crafted flow distributor 40 and will then percolate downward, in the direction of arrow B, through the GAC where chemical contaminants will be more effectively adsorbed due to the even distribution of the flow. Prior art systems lack in efficiency of adsorption due in large part to how the water stream enters the system and thereafter flows downward through the treatment substance. The distribution of the water stream at the initial point of introduction in prior art devices fails to evenly distribute and evenly spread out the water stream at this critical point. The flow distributor 40 of the present invention (which will be described in greater detail below) directly meets this problem. As the water stream enters the tank, it engages the flow distributor 40 which evenly spreads out the water stream over its sectional radiating spoke-finger slots 43, 45 and thereby forces an even horizontal distribution of the water stream fully over the treatment substance from top to bottom for more efficient adsorption.

After adsorption therethrough, the water stream exits the column assembly 30 via the outlet port 54 and into the outlet pipe 114 of the first stage array and toward the rear of the array, in the directions of arrow B. The three-way discharge valve 18 at the discharge pipe 14 is in a closed position to outlet pipe 114 of the first stage and is in the open position to outlet pipe 214 of the second stage (this is referred to as position Y). In the Y position, the water exiting the column assemblies 30 of the first stage must flow rearward to a crossover point. FIG. 4 illustrates the cross-over structure. As water flows through outlet pipe 114 in the direction of arrow B, it passes through a first two-way valve 17 which is in the open position (position X) thereby permitting the water to flow into the second stage inlet pipe 212 in the direction of arrow BA and into the inlet ports 52′ and up the cartridge flow pipe 33′ of each column assembly 30′ of the second stage array.

As in stage one, the water stream percolates downward in the direction of arrow BB during which chemical contaminants are adsorbed. After adsorption therethrough, the water stream exits each column assembly 30′ via the respective outlet port 54′ and toward the front of the array in the directions of arrow BB in outlet pipe 214. A second cross-over two-way valve 19 is closed (position Y) to prevent the water stream from crossing over and re-entering inlet pipe 112 (when the water flow is reversed making original stage one now stage two and making original stage two now stage one, the positions of these cross-over valves are reversed, first cross-over valve 17 is closed [position Y] and second cross-over valve 19 is open [position X] to thereby permit water to flow from the outlet pipe 214 in the direction of arrow BA′ through cross-over valve 19 to inlet pipe 112).

The water stream flows to and through a three-way discharge valve 18 which, for this description, is in the open position between outlet pipe 214 of the second stage and the discharge pipe 14 but is in the closed position to the first stage; i.e., between the outlet pipe 114 of the first stage and the discharge pipe 14 (for reference purposes, this is position Y; position X for the discharge valve 18 is in a closed position for stage two thereby preventing the flow from outlet pipe 214 to discharge pipe 14 and open for stage one to direct the water stream to the discharge pipe 14 from the first stage outlet pipe 114). In position Y, fully treated water is discharged from the system in the direction of arrow C.

Therefore, to initiate the water treatment process, inlet valve 16 is in position X directing the water stream to the first stage array via inlet pipe 112 to inlet port 52 for treatment therein, out outlet port 54 after treatment therein, back toward the rear via outlet pipe 114, through the open first cross-over valve 17 (in position X), to the second stage inlet pipe 112 to inlet port 52′ for treatment therein, out outlet port 54′ after treatment therein, toward the front via outlet pipe 214, through discharge valve 18 (in position Y) and out the discharge pipe 14. The second cross-over valve 19 is in position Y for this operation. When the first stage adsorption materials have been exhausted, the system may be shut down and the cartridges 31 of the first stage removed and replaced with new cartridges 31. After such replacement, all valves 16, 17, 18, 19 are reversed (i.e., valves 16, 17 placed into position Y and valves 18, 19 placed into position X) and the original second stage (with partially exhausted adsorption substance) now becomes the first stage and the original first stage (with the new, unused adsorption substance) becomes the second stage. The rationale here is to use the partially exhausted adsorption substance first since it will require replacement soon nonetheless.

The chemical-treatment system is designed to treat typical chemical contaminants, such as benzene and MTBE from leaking underground storage tanks. On average, these toxic trace chemicals generally will saturate a eight-column first-stage (with each column containing only about 100 pounds GAC; the dimensions of the column cartridges 31 described below) in about three months. It must be understood that the cartridges may be sized larger or smaller and thereby contain more or less GAC; but, to maintain the efficiency, effectiveness, and fiscal soundness of the system, cartridges should be designed such that they contain between about 50-200 pounds GAC. Other environmental factors and excessive contamination would of course shorten that time period. Regardless, when the first-stage becomes saturated with chemicals, the chemicals (or traces thereof) will be discharged from the outlet port 54. A chemical monitoring sensor assembly 20 is mounted on one or more column assemblies 30, 30′ of each stage array (generally the first column assembly 30, 30′) of the array. This sensor assembly 20 will detect such chemicals (or predetermined acceptable/non-acceptable levels thereof) as they exit the saturated first-stage. When the flow of the water stream is reversed, a sensor assembly 20′ on a column assembly 30′ of the second stage (generally the first such column assembly 30′ in the array) will then begin monitoring for chemicals and so on. An alarm alerts the operator and/or management personnel when chemical saturation (or the predetermined acceptable level) is realized thereby signaling a need to replace the spent cartridges 31, 31′.

It must be understood that the system need not be reversed at all but may continue to operate as before; i.e., first stage remaining first and the second stage remaining second. It must also be understood that the entire system need not be shut down at all to replace the first stage cartridges 31 but that only the first stage need be shut down while the second stage continues operation. In this regard, all the control valves 16, 17, 18, 19 would be placed in position Y. The configuration of the present invention permits greater flexibility with these alternatives and it is left to the operator's discretion to choose which best suits the needs of the community; i.e., complete shut down during replacement, or no shut down during replacement. Using cartridges 31 containing about 100 pounds of GAC, as envisioned by this system, it requires about one hour to replace eight cartridges 31 in a system comprised of two eight-column arrays. In an area having typical environmental conditions and contaminations as earlier described, this would be done about once every three months at which time a delivery truck drops off the new cartridges and picks up and removes the spent cartridges.

Breaking down the column assembly 30, 30′ and/or adding or removing column assemblies 30, 30′ to/from an array is also facilitated by its unique construction. Simply put, it is comprised of a base 51 and a removable cartridge 31. The cartridge 31 has a removable cap 36 at the top and a removable mounting member 62 at the bottom. A holding screen 35 is securely contained in the mounting member 62. The mounting member 62 has a flanged upper and lower surface as does the cartridge 31. The mounting member 62 is securely attached to the bottom of the cartridge, which has a mating flange design and an O-ring groove, by a suitable clamping device 32 such as, but not limited to, a V-clamp and nut assembly as produced by CLAMPCO® which also has a mating flange design and an O-ring groove between the mating flange components of the mounting member 62 and the cartridge 31. Use of this, or a similar clamping device maintains a water-tight integrity for the column assembly 30 and facilitates removal of the cartridge 31 from the base 51 and replacement with a new cartridge 31. The holding screen 35 inside mounting member 62 prevents the adsorption substances within the cartridge 31 from falling from the cartridge 31 as the cartridge 31 is removed, moved, replaced.

The inlet ports 52, 52′ and the outlet ports 54, 54′ and the respective inlet/outlet pipes to which they are connected and connectable may also be flanged or have a lipped surface which are matable with their flanged counterparts. A clamping device 32, as described above, secures these components to one another and to the system. In this way, a system which, because of limited filtration/adsorption needs, may have begun with a eight-column array per stage now finds its needs, whether environmental or financial, require a 50-100% increase. It is relatively simple to add the four or eight, or more, additional column assemblies 30.

The holding screen 35 also functions as a coupling means between the base flow pipe 53 and the cartridge flow pipe 33 each of which may either fit into the aperture 46 of the holding screen 35 or over an extension of the aperture 46. As to the former, the outside diameters of the respective flow pipes 33, 53 are slightly smaller than the inside diameter of the screen aperture 46. A suitable sealing member, such as, but not limited to an O-ring 44 in a receiving groove 64 is on and between the outside diameters of the respective flow pipes 33, 53 and the inside diameter of the screen aperture 46. Where the screen aperture 46 has an extension on both sides thereon, it is upon and over this extension that the respective flow pipes 33, 53 are seated. In such configurations, the outside diameter of the extension is smaller than the inside diameters of the respective flow pipes 33, 53. As before, a suitable sealing member, such as, but not limited to an O-ring 44 and receiving groove 64, is on and between the inside diameters of the respective flow pipes 33, 53 and the outside diameter of the extension on the screen aperture 46.

The mounting member 62 remains attached to the bottom of the cartridge 31 during this removal process and transportation to a suitable collection facility. After the cartridge 31, with its spent adsorption substance is taken to the collection facility, the clamp device 32 which attaches the mounting member 62 to the bottom of the cartridge 31 is removed and the spent adsorption substance is removed, the chamber 37 cleansed and/or detoxified, and re-charged/re-filled with a new/clean adsorption substance. The holding screen 35 is likewise cleansed and/or detoxified and the screen-like material therein is inspected and/or replaced. After this maintenance has been completed, the mounting member 62 (with holding screen 35 therein) is re-attached to the re-charged cartridge 31 and readied for re-use as needed.

The top or cap 36 to the cartridge 31 is similarly constructed and removably attachable to the top of the cartridge 31. In this regard, the cap 36 is flanged in mating cooperation with the flange on the top of the cartridge 31 and securely attached thereto by a suitable clamping device 32 (as previously described). The cap 36 secures to the cartridge 31, in basically the following order downward, the flow distributor 40 and the holding screen 35 on the top of the cartridge 31. The holding screen 35 on the top is similarly constructed as the holding screen 35 on the bottom having an aperture 46 therein to facilitate and accommodate coupling of the cartridge flow pipe 33 to the flow distributor 40. In cases where the flow distributor 40 has an extending member 48, the outside diameters of the extending member 48 and the cartridge flow pipe 33 are smaller and couple into the screen aperture 46 and are sealed thereat by, for example, O-rings 44.

In cases where the screen aperture 46 is configured with extensions, the aperture 49 of the flow distributor 40 and the opening of the cartridge flow pipe 33 each mate over the extending member 48 and are sealed thereat by O-rings 44 and cooperating receiving grooves 64 in between. In this configuration the outside diameter of the extension is smaller than the inside diameters of the cartridge flow pipe 33 and the flow distributor aperture 49. The base flow pipe 53 is removably seated into the base plate 50 in a similar fashion; i.e., either over an upward extension of the base plate 50 or into an upward extension or opening in the base plate 50. In either case, suitable sealing members 44 and cooperating receiving grooves 64 seal the connection.

When all connections, couplings, and attachments are made, an a flow path from inlet port 52 to/through base flow pipe 53, to/through cartridge flow pipe 33, to/through flow distributor aperture 49, over the flow distributor 40, into the cartridge chamber 37 and adsorption substance therein, and down and out the outlet port 54.

Each cartridge 31 holds about 100 pounds of carbon. The empty weight of the cartridge 31 is approximately 50 pounds. Each cartridge 31 is about eight inches in diameter and about four feet in height. The overall light weight of each cartridge 31 makes its removal, replacement, cleaning, detoxification, maintenance, and transportation remarkably simple. Special cradle-shaped pallets are designed to hold several cartridges 31 (spent or new) per pallet layer. The layers are stackable upon one another. As illustrated in FIG. 9, four cartridges 31 are seated in a four-cradle pallet with three additional pallet layers stacked atop the bottom pallet thereby making the pallet assembly 70 a four-tier assembly. These pallets are used to transport the clean carbon-filled cartridges to the job site and return the spent cartridges 31 filled with used/wet carbon to the central collection facility.

Reference now should be made to FIGS. 2 through 6 which illustrates the column assembly 30 in detail. As described above, the water is forced into the column assembly 30 through the inlet port 52. The natural pressures of the water stream force this water stream into the column assembly 30 up to the top through the cartridge flow pipe 33 where a flow distributor 40 thereat evenly distributes the water stream into the cartridge flow chamber 37 and adsorption substance 39. Holding assemblies 35, at the top and the bottom (in the mounting member 62) of the cartridge flow chamber 37 securely hold suitable adsorption substance 39, such as, but not limited to, granular activated carbon (GAC) 39 within the cartridge flow chamber 37. The upper and lower holding assemblies 35 hold the GAC 39 in place with mesh-like/screen-like material therein to thereby permit the flow of the water stream therethrough.

The water stream percolates down through the packed GAC 39 and out of the column assembly 30 through the outlet port 54. Conventional sensor assemblies 20 (such as ultrasonic level sensors) monitor and control the water stream. The sensor assembly 20 is in communication with the cartridge flow chamber 37 and detects the contamination level therein. The sensor assembly 20 is generally located above the cartridge exit port 54.

The sensor assembly 20 can be any conventional sensing unit suited for the intended purpose. Typical sensor assemblies include an Optiquant Chemical Analyzer which is distributed by Hach Company, or its equivalent. Such sensor assemblies 20 are adapted to monitor various water contamination levels and to detect the need to replace the cartridge 31. When the contamination level of the water exiting the column assembly 30 reaches a pre-determined level, an alarm is set off to alert staff personnel of this situation.

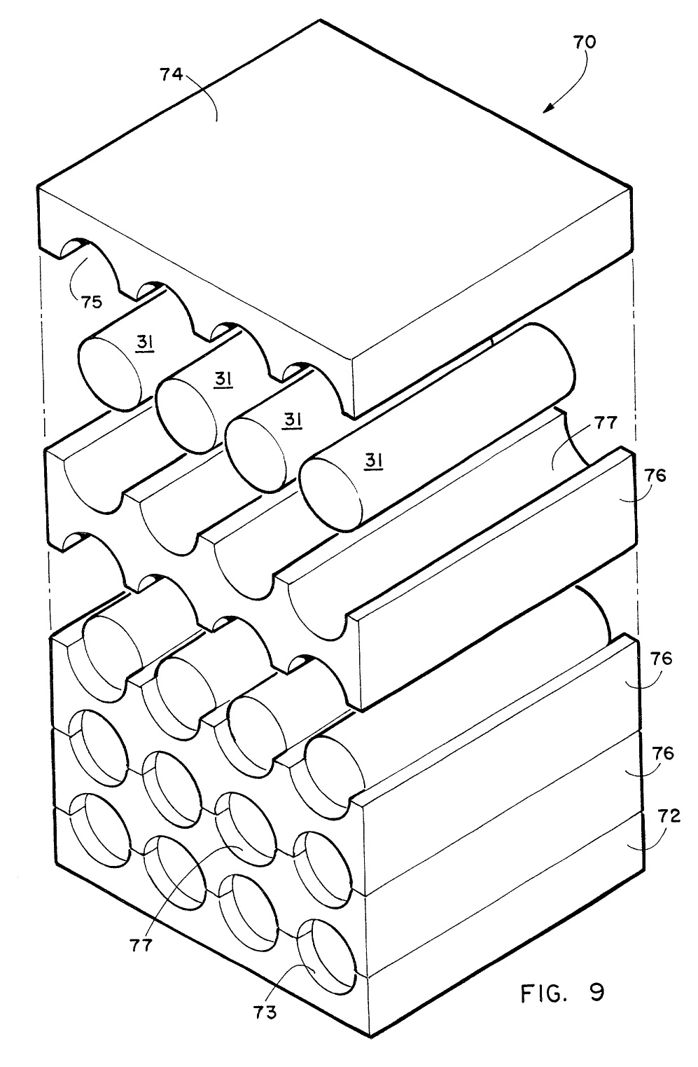

The flow distributor 40 is a unique feature of the column assembly 30 (FIGS. 7 and 8 pertain). It is located adjacent to the top of the column assembly 30 above the upper holding assembly 35. At the center of the flow distributor is an aperture 49 which facilitates coupling of the cartridge flow pipe 33 to the flow distributor 40 (as previously described) and permits entry of the water stream from the cartridge flow pipe 33 into and over the flow distributor 40 down through the adsorption substance 39. Radiating from the center of the flow distributor 40 are a plurality of spokes or fingers 45 of varying lengths. These fingers 45 are basically flat surfaces having at the distal ends, a slot 43. One finger 45 and one slot 43 is a finger/slot set. The flow distributor 40 may have one or more finger/slot sets for a section 41. A wall or raised ridge 47 may, but need not be between each finger/slot set. I have found that between six to 14 such finger/slot sets will function well. In addition, the flow distributor 40 may have one or more sections 41 of such finger/slot sets. Good results are obtained with about four to 12 sections 41 bearing between about six to 14 finger/slot sets; although more or less of either (section or set) will also suffice. Best results are obtained with about eight sections bearing between about nine to 11 finger/slot sets. Additionally, where each section 41 contains a plurality of finger/slot sets, for best flow distribution, I have found that the slot 43 of each succeeding finger 45 should be larger than the slot 43 of the previous finger 45 until the final slot 43 has no finger 45 or the finger 45 is merely a stub. In other words, the first finger 45 to a section 41 of a finger/slot set may have a small slot 43 (or slit) or none at all. The next finger 45 of a finger/slot set has a larger slot 43 and so on in the same direction. When the finger 45 of the last finger/slot set of a section 41 is a stub or none at all (approximately a near-full slot or a full slot), the next section 41 begins.

The functionality of the flow distributor 40 cannot be understated. With the relatively flat fingers 45 a water stream flows evenly over the flat fingers 45 and up to and out of the slot 43. The length of the slot 43 for each succeeding finger 45 becomes larger and larger. The water stream flows into the smallest distal slot 43 near to the outer perimeter of the cartridge flow chamber 37 and incrementally, with the adjacent slots 43, nearer and near to the center; repeatedly for each succeeding flow section 41. A even distribution of the water stream is fed into the cartridge flow chamber 37 for a more efficient filtration/adsorption effect. Conventional nozzles or jets or the staggered-baffle system as previously described will become plugged or clogged with various contaminants, such as, but not limited to slime, scale, and calcium. This will diminish the effectiveness of the column and require more frequent replacement and extended down-time to complete the procedure.

With the flow distributor 40 of the present invention, any build-up occurs on the flat surfaces of the fingers 45, and only at the drop-off edge of the slots 43. The water stream is relatively unimpeded and, over time, when an obstructing build-up does occur, maintenance is simple. The column cap 36 and flow distributor 40 are easily removed. The offending contaminants then may simply be scraped off, dissolved with acid or its equivalent, or replaced with a new flow distributor 40. If the carbon substance is spent, the cartridge 31 is easily replaced. In either event, disruption of use of the column assembly 30, and effect on the entire system, is minimized.

The method of the present invention envisions use of at least two stages of one or more column assemblies 30, 30′, each having a self-contained removable cartridge 31, 31′ which houses a suitable adsorption substance 39; preferably GAC. The cartridges 31 are relatively light in weight when empty, when filled with fresh GAC, or when containing spent wet GAC. They are self-contained and easily detachable from the base 51. For cost-effectiveness, the system also envisions using 10-20 column assemblies 30, 30′ for each stage. As described above, when the sensor assembly 20 signals the contamination saturation level for one stage, each column assembly 30 or 30′, as the case may be, for the respective stage is removed and replaced with a cartridge containing fresh GAC. The system may (but need not) be shut down, as described above by closure of the valves previously described, the V-clamp 32 attaching the mounting member 62 to the base 51 is removed, followed by the removal of the spent cartridge 31 and replacement onto that base 51 of a cartridge 31 containing fresh GAC.

The spent cartridge 31 is placed onto a cradle 73 of a specially molded pallet bottom 72. This pallet bottom 72 has several cradles 73 specially designed to receive and hold therein the cartridge 31. Typically, for efficiency, a typical pallet bottom 72 should have between three to five cradles 73. After each cradle 73 is filled with a cartridge 31, a central pallet 76, with corresponding cradles 77, on its bottom surface and on its top surface, is fitted over the bottom pallet 72. The respective cradles 73, 77 align within one another and snugly hold the cartridges 31 placed therein. The top surface of the central pallet 76, with its cradles 77 exposed, are at ready to accept additional cartridges 31.

As can be understood, this pallet assembly 72, 76 may be built up to three or more tiers as necessary to accommodate the cartridges 31 being removed from the system. In the system described above, involving an eight-column array per stage, four tiers of four cartridges 31 provide for an efficient replacement process. When no more cartridges 31 are to be placed into the pallet assembly 70, a pallet bottom 72 may be overturned to become a pallet top 74, with corresponding cradles 75. It is placed over the last central pallet 76 to create a fully loaded, multi-tiered pallet assembly 70. In cases where only one tier is desired, a pallet top 74 is placed over a pallet bottom 72 after the cartridges 31 are loaded into the cradles 73. The pallet assemblies 70 are secured by banding, tying, or any suitable securing means, and are thereby easily placed on a conventional truck or similar transport vehicle and removed to a suitable collection facility. Fresh cartridges 31 are similarly transported by the same pallet assemblies 70.

In an eight-column stage, the process would be as follows. A pallet assembly 70 having four tiers with each tier containing four fresh cartridges 31 would be delivered to a treatment site. The pallet assembly 70 is unbanded and the top pallet 74 removed thereby exposing four fresh cartridges 31. The top pallet is overturned to lie on its flat surface on the ground. In this manner, the top pallet 74 exposes its cradles 75 and in essence become a bottom pallet. As spent cartridges 31 are removed from the column assembly 30, they are placed into the top pallet 74 cradles 75. Fresh cartridges 31 are taken from the pallet assembly 70. When all the fresh cartridges 31 from the pallet assembly 70 have been removed from the first central pallet 76, that central pallet 76 is placed on the former top pallet 74 housing the spent cartridges. As the fresh cartridge pallet assembly becomes depleted, a new pallet assembly containing spent cartridges is simultaneously erected. After the last fresh cartridge has been removed from the fresh cartridge pallet assembly, the bottom pallet of that fresh cartridge pallet assembly will become the top pallet of the spent cartridge assembly which will then be tied or banded for transportation. As can easily be seen, use of the cartridges of the present invention in conjunction with the pallet assemblies and method of removal and replacement will save steps, time, manpower, equipment, and money.

Transportation by common carrier of the banded pallet of cartridges full or spent carbon is inexpensive, easy to perform, and does not require special trucks, special equipment, or specially-trained personnel. A person need only remove V-clamps 32 holding the mounting member 62 to the base 51. Once the V-clamp 32 is removed, the cartridge 31 may be lifted, by as few as a single person (or with the help of a movable hoist assembly), from the base 51. The holding screen 35 and mesh-like member 38 maintain the carbon within the cartridge 31. Each cartridge 31 fits neatly into the cradle pallet.

If the chemical contaminants in the water supply increase unexpectedly, a special carbon replacement delivery can easily be made within a few days and/or, if necessary based on the contamination levels in the water stream, the entire system may be resized simply by adding additional column assemblies 30 with cartridges 31 of fresh carbon to increase the number of column assemblies 30 in the array. The quick-connect V-clamps make carbon replacement or adding more column assemblies to an array simple.

The present disclosure includes that contained in the present claims as well as that of the foregoing description. Although this invention has been described in its preferred forms with a certain degree of particularity, it is understood that the present disclosure of the preferred form has been made only by way of example and numerous changes in the details of construction and combination and arrangement of parts and method steps may be resorted to without departing from the spirit and scope of the invention. Accordingly, the scope of the invention should be determined not by the embodiments illustrated, but by the appended claims and their legal equivalents.

The invention claimed is:

1. A system for the treatment of chemical-contaminated drinking water comprising:
one or more first stage treatment column;
one or more second stage treatment column;
each of said one or more first stage treatment column and each of said one or more second stage treatment column comprises an inlet port, an outlet port, a base having a base plate and a base flow pipe in said base plate and in communication with said inlet port, a cartridge detachable from said base, said cartridge having a top and a bottom and adapted to hold a treatment therein, holding means for holding said treatment substance within said cartridge, a flow pipe within said cartridge attached to said base flow pipe, and a flow distributor at the top of said cartridge in communication with said flow pipe;
inlet means for selectively directing a stream to the inlet port of said one or more first stage treatment column or to the inlet port of said one or more second stage treatment column; and
outlet means for selectively directing a stream from the outlet port of said one or more first stage treatment column to the inlet port of said one or more second stage treatment column or from the outlet port of said one or more second stage treatment column to the inlet port of said one or more first stage treatment column.

2. The system according to claim 1 wherein said holding means at the top of said cartridge comprises a holding screen having a screen aperture therein adapted to receive on one side said flow pipe and on the other side to receive said flow distributor.

3. The system according to claim 2 further comprising a coupling means for removably coupling said flow distributor to said screen aperture and for removably coupling said flow pipe to said screen aperture.

4. The system according to claim 3 wherein said coupling means comprises an extending member on said flow distributor, and further comprising said extending member and said flow pipe each having an outside diameter smaller than an inside diameter of said screen aperture and further having a sealing member in mating communication between said screen aperture and said extending member and said flow pipe.

5. The system according to claim 3 wherein said coupling means comprises an extending member on said screen aperture and a flow aperture on said flow distributor, and further comprising said flow aperture and said flow pipe each having an inside diameter larger than an outside diameter of said extending member of said screen aperture and further having a sealing member in mating communication between said extending member of said screen aperture and said flow aperture and said flow pipe.

6. The system according to claim 1 wherein said holding means at the bottom of said cartridge comprises a mounting member having a holding screen with a screen aperture thereon adapted to receive on one side said flow pipe and on the other side to receive said base flow pipe.

7. The system according to claim 6 further comprising a coupling means for removably coupling said base flow pipe to said screen aperture and for removably coupling said flow pipe to said screen aperture.

8. The system according to claim 7 wherein said coupling means comprises said base flow pipe and said flow pipe each having an outside diameter smaller than an inside diameter of said screen aperture and further having a sealing member in mating communication between said screen aperture and said base flow pipe and said flow pipe.

9. The system according to claim 7 wherein said coupling means comprises an extending member on said screen aperture wherein said base flow pipe and said flow pipe each have an inside diameter larger than an outside diameter of said screen aperture extending member and further having a sealing member in mating communication between said screen aperture extending member and said base flow pipe and said flow pipe.

10. The system according to claim 6 further comprising attachment means for removably attaching said cartridge to said mounting member, for removably attaching said mounting member to said base, and for removably attaching a cap on the top of said cartridge from said cartridge.

11. The system according to claim 10 wherein said attachment means comprises a flange on the top and on the bottom of said cartridge, a flange on a top and bottom of said mounting member, a flange on said base, a flange on said cap, and a v-clamp device in mating cooperating with said cap flange to said cartridge top flange, with said cartridge bottom flange and said mounting member top flange, and with said mounting member bottom flange and said base.

12. The system according to claim 1 wherein said inlet means comprises a three-way valve attached to an inlet pipe, said inlet pipe attached to each said inlet port of said one or more first stage treatment column and to each said inlet port of said one or more second stage treatment column wherein the inlet pipe of said one or more first stage treatment column, at a first cross-over point[19], crosses over to an outlet pipe attached to said outlet port of each one of said one or more second stage treatment column and the inlet pipe of said one or more second stage treatment column, at a second cross-over point[17], crosses over to an outlet pipe attached to each said outlet port of said one or more first stage treatment column.

13. The system according to claim 12 further comprises a two-way valve at said first cross-over point and at said second cross-over point.

14. The system according to claim 12 wherein said outlet means comprises a three-way valve attached to an outlet pipe, said outlet pipe attached to each said outlet port of said one or more first stage treatment column and to each said outlet port of said one or more second stage treatment column.

15. The system according to claim 1 wherein said flow distributor comprises one or more spoke-slot sets to comprise a section, wherein each sequential spoke-slot set, of the one or more spoke-slot sets, adjacent to a previous spoke-slot set has slot therein larger than the slot of the previous spoke-slot set.

16. The system according to claim 15 wherein said one or more spoke-slot sets comprises between six to twelve spoke-slot sets.

17. The system according to claim 15 wherein said flow distributor comprises one or more sections of said one or more spoke-slot sets.

18. The system according to claim 17 where said one or more sections comprises between about four to twelve sections.

19. The system according to claim 1 further comprising sensing means for detecting contamination build-up of said treatment substance and signaling a need to replace said treatment substance.

20. A method for the treatment of chemical-contaminated drinking water comprising the method steps of:
providing a first stage column array having two or more treatment column assemblies;
providing a second stage column array having two or more treatment column assemblies, wherein each of said column assemblies have an inlet port, an outlet port, and a removable cartridge adapted to contain a treatment substance of between about 50 to 200 pounds of said treatment substance;
providing an inlet means for selectively directing a water stream to the inlet port of said two or more first stage treatment column assemblies or to the inlet port of said two or more second stage treatment column assemblies; and
providing an outlet means for selectively directing a water stream from the outlet port of said two or more first stage treatment column assemblies to the inlet port of said two or more second stage treatment column assemblies or from the outlet port of said two or more second stage treatment column assemblies to the inlet port of said two or more first stage treatment column assemblies.

21. The method according to claim 20 further comprising the step of removing one or more said cartridge on-site from said treatment column assemblies of the first stage column array or from the second stage column array when said treatment substance within said one or more cartridge is spent and replacing said one or more removed spent cartridge with one or more cartridge containing fresh said treatment substance.

22. The method according to claim 21 further comprising the step of
(a) bringing a pallet assembly containing a plurality of said cartridges containing said fresh treatment substance to said on-site location of said treatment column assemblies, said pallet assembly having a plurality of pallet sections each having a plurality of cradles thereon each of which are adapted to hold one of said plurality of said cartridges containing said fresh treatment substance;
(b) removing a pallet section to thereby expose a row of said plurality of said cartridges containing said fresh treatment substance;
(c) using said removed pallet section, with said plurality of cradles exposed, as a spent pallet section for receiving said spent cartridges;
(d) placing one or more of said removed spent cartridges into one or more of said plurality of cradles of said removed pallet section;
(e) using one or more of said cartridge containing said fresh treatment substance from said pallet assembly and attaching one or more of said cartridge containing said fresh treatment substance onto said column assembly in place of said one or more of said removed spent cartridge; and
(f) repeating methods (b), (c), (d), and (e) as necessary to create a new pallet assembly of said spent cartridges.

23. The method according to claim 21 further comprising the step of sensing when said treatment substance within one or more of said cartridge has become spent.
